(19) United States
(12) Patent Application Publication
(10) Pub. No.: US 2023/0177597 A1
(43) Pub. Date: Jun. 8, 2023

(54) INFORMATION PROCESSING SYSTEM, INFORMATION PROCESSING DEVICE, DISPLAY TERMINAL, INFORMATION PROCESSING METHOD, AND COMMUNICATION METHOD

(71) Applicant: Panasonic Intellectual Property Management Co., Ltd., Osaka (JP)

(72) Inventors: Kazuhiko YAMAUCHI, Osaka Fu (JP); Hiroshi KATO, Tokyo To (JP); Takenori MATSUMOTO, Tokyo To (JP); Akinori OZEKI, Kanagawa Ken (JP); Chinatsu YONEYAMA, Kanagawa Ken (JP); Masashi FUMOTO, Kanagawa Ken (JP); Matthew KAMIYA, Tokyo To (JP); Tatsuyuki NEGISHI, Tokyo To (JP); Kiyotaka TANIMOTO, Kanagawa Ken (JP)

(73) Assignee: Panasonic Intellectual Property Management Co., Ltd., Osaka (JP)

(21) Appl. No.: 17/884,315

(22) Filed: Aug. 9, 2022

(30) Foreign Application Priority Data
Nov. 25, 2021 (JP) 2021-191315

(51) Int. Cl. G06Q 30/06

(52) U.S. Cl. CPC G06Q 30/0645

(57) ABSTRACT

An information processing system according to the present disclosure includes an owner terminal, a user terminal, and a management device. The owner terminal outputs vehicle information indicating whether at least a partial period of a lendable period is designated as a standing period in which a vehicle is not traveling. The user terminal outputs driver’s license information indicating whether a user is holding a driver’s license. The managing apparatus selects a vehicle at least a vehicle cabin of which is available to the user from a plurality of vehicles including a vehicle in a standing period in a lendable period, based on matching permission information, in which correspondences among whether vehicles are in respective standing periods, whether users are holding respective driver’s licenses, and whether vehicle lending is permitted are registered in advance, the vehicle information, and the driver’s license information, and outputs information indicating the selected vehicle.

### CROSS-REFERENCE TO RELATED APPLICATIONS

This application is based upon and claims the benefit of priority from Japanese Patent Application No. 2021-191315, filed on Nov. 25, 2021, the entire contents of which are incorporated herein by reference.

### Field

Embodiments described herein relate generally to an information processing system, an information processing device, a display terminal, an information processing method, and a communication method.

### BACKGROUND

Conventionally, there has been a demand for use of private room spaces for uses such as web conferencing and breaks in a mobile environment away from home or office. The private room space is a space that is partitioned from the outside to have soundproofing and shielding properties suitable for use in web conferencing or work that requires attention to information leakage, for example.

In the mobile environment, examples of the private room space available for uses such as web conferencing and breaks include rental conference rooms, independent box-type private meeting rooms, and hotel rooms, and users have reserved private room spaces at locations desired to use them to secure private room spaces in the mobile environment (e.g., Japanese Patent Application Laid-open No. 2020-052698).

However, there is a high demand for private room spaces, and it is sometimes difficult to secure private room spaces at locations desired to be used. In addition, there is a problem in that rental conference rooms and hotel rooms are not cost-effective when used by one person. In addition, there is a problem in that although independent box-type private meeting rooms provide good sound insulation, they require a sitting posture in a business chair, for example, and are not suitable for a rest involving lying down. In addition, in some cases, there are no rental conference rooms, hotel rooms, or private meeting rooms at locations desired to be used by users.

A problem to be solved by the present disclosure is to present private room spaces suitable for a mobile environment to users.

### SUMMARY

An information processing system according to the present disclosure includes an owner terminal, a user terminal, and a management device. The owner terminal is configured to output vehicle information including a lending condition indicating whether at least a partial period of a lendable period is designated as a standing period in which a vehicle is not traveling. The user terminal is configured to output driver’s license information indicating whether a user is holding a driver’s license. The management device is configured to: select, based on matching permission information, in which correspondences among whether vehicles are in respective standing periods, whether users are holding respective driver’s licenses, and whether vehicle lending is permitted are registered in advance, the vehicle information from the owner terminal, and the driver’s license information from the user terminal, a vehicle at least a vehicle cabin of which is available to the user from among a plurality of vehicles including a vehicle in a standing period in a lendable period; and output information indicating the selected vehicle at least the vehicle cabin of which is available to the user terminal.

### BRIEF DESCRIPTION OF THE DRAWINGS

FIG. 1 is a block diagram of an example of a configuration of a private room space matching system according to an embodiment;

FIG. 2 is a block diagram of an example of a configuration of a user terminal according to the embodiment;

FIG. 3 is a block diagram of an example of a configuration of an owner terminal according to the embodiment;

FIG. 4 is a block diagram of an example of a configuration of a management device according to the embodiment;

FIG. 5 is a diagram of an example of management information according to the embodiment;

FIG. 6 is a diagram of an example of matching permission information according to the embodiment;

FIG. 7 is a sequence diagram of an example of private room space matching processing according to the embodiment;

FIG. 8 is a diagram of an example of a display screen displayed in the private room space matching processing according to the embodiment;

FIG. 9 is a diagram of an example of a display screen displayed in the private room space matching processing according to the embodiment;

FIG. 10 is a diagram of an example of a display screen displayed in the private room space matching processing according to the embodiment;

FIG. 11 is a diagram of an example of a display screen displayed in the private room space matching processing according to the embodiment;

FIG. 12 is a diagram of an example of a display screen displayed in the private room space matching processing according to the embodiment; and

FIG. 13 is a diagram of an example of a configuration of a private room space matching system providing a private room space matching service via an application programming interface (API) according to another embodiment.

### DETAILED DESCRIPTION

The following describes embodiments of an information processing system, an information processing device, a display terminal, an information processing method, and a communication method according to the present disclosure with reference to the accompanying drawings.

In the description of the present disclosure, components having the same or substantially the same functions as those described above with respect to the drawings already shown may be denoted by the same symbols, and descriptions thereof may be omitted as appropriate. In some cases, even when the same or substantially the same part is represented, its dimension and proportion may be represented differently depending on the drawings. From the viewpoint of ensuring the visibility of the drawings, for example, reference symbols may be attached only to major components in the description of each drawing, and even components having the same or substantially the same functions as those described above in the drawings already shown may not be attached with reference symbols.

### First Embodiment

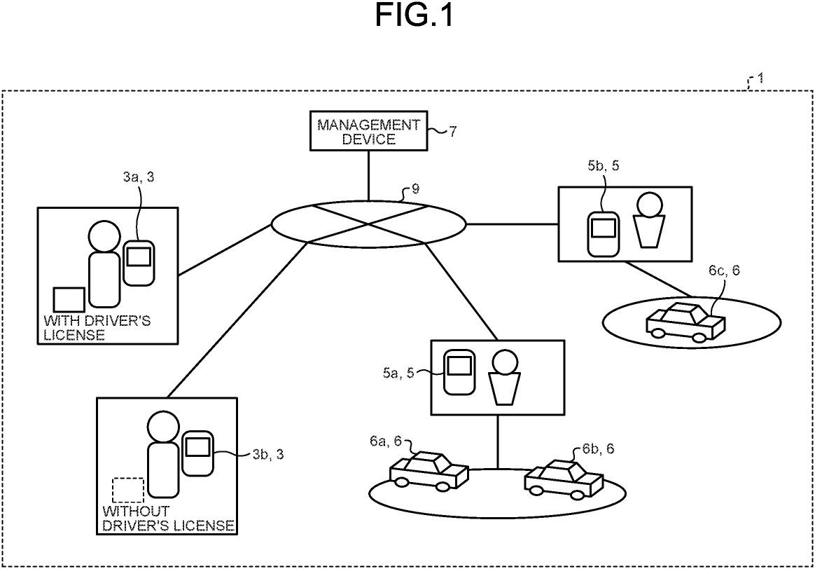

FIG. 1 is a block diagram of an example of a configuration of a private room space matching system 1 according to an embodiment. The private room space matching system 1 according to the embodiment is a system configured to implement a private room space matching service matching an owner’s demand to lend out a vehicle cabin of a vehicle as a private room space and a user’s demand to borrow a private room space suitable for a mobile environment, not limited to the vehicle cabin, with each other at least on condition of the presence of holding a driver’s license. The private room space matching system 1 is an example of an information processing system.

As illustrated in FIG. 1, the private room space matching system 1 includes user terminals 3, owner terminals 5, and a management device 7. The user terminals 3, the owner terminals 5, and the management device 7 are connected to each other in a communicable manner via a network 9. The private room space matching system 1 is constructed as a server-client type system including the management device 7 as a server apparatus and the user terminals 3 and/or the owner terminals 5 as client apparatuses, for example. The management device 7 is an example of an information processing device. A user terminal 3 is an example of a display terminal.

The user terminal 3 is an operating terminal used by a user who is looking for a vehicle cabin to be used as a private room in the private room space matching service, that is, a user who wants to borrow a private room space suitable for the mobile environment through the private room space matching system 1. The user terminal 3 is an operating terminal outputting driver’s license information 322 including driver’s license holding information indicating whether the user is holding a driver’s license and driver’s license carrying information indicating whether the user is in a state of carrying the driver’s license. As the user terminal 3, various portable terminals can be used as appropriate, such as notebook personal computers (PCs), tablet terminals, smartphones, and wearable devices such as smart watches. Stationary terminals such as ordinary PCs may also be used as the user terminal 3.

FIG. 1 exemplifies user terminals 3a and 3b as the user terminal 3. The user terminal 3a is an example of the user terminal 3 used by the user who holds a driver’s license. The user terminal 3b is an example of the user terminal 3 used by the user who does not hold a driver’s license. In the private room space matching system 1, there may be one unit, or three or more units of a plurality of user terminals 3.

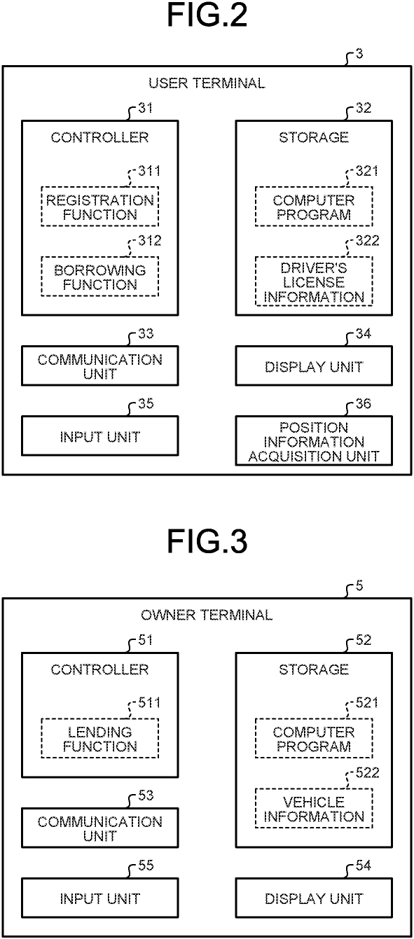

FIG. 2 is a block diagram of an example of a configuration of the user terminal 3 according to the embodiment. As illustrated in FIG. 2, the user terminal 3 has a controller 31, a storage 32, a communication unit 33, a display unit 34, an input unit 35, and a position information acquisition unit 36.

The controller 31 controls the entire operation of the user terminal 3. The controller 31 has a processor and a memory as its hardware configuration. The controller 31 executes a computer program 321 loaded onto the memory by the processor to implement a registration function 311 and a borrowing function 312.

In the registration function 311, the controller 31 registers the driver’s license holding information of the user. As an example, the controller 31 registers photograph data taking both sides of a driver’s license. Specifically, the controller 31 acquires the photograph data taking both sides of the driver’s license by the input unit 35. The controller 31 determines the validity of the acquired photograph data of the driver’s license. The validity of the acquired photograph data of the driver’s license can be determined in accordance with the readability of the description, for example. If determined to be valid, that is, the taken photograph data is authenticated as a driver’s license, the controller 31 updates the driver’s license holding information in the driver’s license information 322 as holding a driver’s license and provides notification that the registration of the driver’s license holding information has completed to the user. The controller 31 transmits the driver’s license holding information to the management device 7 by the communication unit 33 and registers the driver’s license holding information in the private room space matching system 1. On the other hand, if the taken photograph data is not authenticated as a driver’s license, the controller 31 provides notification that the registration of the driver’s license holding information could not complete to the user as a registration error.

Although the present embodiment exemplifies a case in which the driver’s license holding information of the user is registered using the photograph data of the driver’s license, this is not limiting. When the description of the driver’s license and information on the presence of driving qualifications can be obtained from outside the private room space matching system 1, such as when information on the driver’s license is associated with a personal number or a social security number, for example, there may be an aspect in which the photograph data of the driver’s license is not used.

In the borrowing function 312, the controller 31 determines a driver’s license holding state of the user. Specifically, the controller 31 reads the driver’s license holding information of the user from the storage 32. The controller 31 determines the presence of electronic consent related to carrying the driver’s license in accordance with the output of the input unit 35 in response to operational input by the user. The controller 31 determines that the user is holding the driver’s license when the driver’s license holding information has been registered and the user has electronically consented to carrying the driver’s license. On the other hand, the controller 31 determines that the user is in a state of not holding a driver’s license when the driver’s license holding information has not been registered or when there is no electronic consent related to carrying the driver’s license. The controller 31 writes the driver’s license carrying information indicating the driver’s license holding state of the user into the storage 32 as the driver’s license information 322. The controller 31 outputs the driver’s license carrying information to the management device 7 by the communication unit 33. The controller 31 displays a display screen showing a vehicle 6 at least the vehicle cabin of which is available to the user selected from a plurality of vehicles 6 including vehicles 6 in a standing period in a lendable period by the display unit 34 based on candidate information acquired by the communication unit 33.

The storage 32 stores therein various types of data for use in the user terminal 3. As illustrated in FIG. 2, the storage 32 records the computer program 321 and the driver’s license information 322.

The driver’s license information 322 is a piece of information on the driver’s license of the user. Specifically, the driver’s license information 322 includes the driver’s license holding information indicating whether the user holds the driver’s license and the driver’s license carrying information indicating whether the user carries the driver’s license. The information indicating whether the user holds the driver’s license is information indicating whether the user has registered the photograph data taking both sides of the driver’s license in the private room space matching system 1, for example. As the information indicating whether the user holds the driver’s license, the photograph data of the driver’s license of the user may be recorded.

The driver’s license information 322 may include information indicating the type of the driver’s license of the user. The type of the driver’s license of the user is the country or region where the driver’s license was issued, the category of the vehicle 6 that the user can drive, or the like. In this case, in the borrowing function 312, the controller 31 may determine the driver’s license holding state further in accordance with whether the driver’s license is valid with respect to the vehicle 6 the vehicle cabin of which is to be borrowed as a private room space. Alternatively, the controller 31 may determine the driver’s license holding state for each type of the driver’s license and record it as the driver’s license information 322.

The communication unit 33 communicates with the outside via the network 9. The communication unit 33 transmits the driver’s license information 322 to the management device 7, for example. The communication unit 33 receives the candidate information from the management device 7. The communication unit 33 is an example of an output unit and an acquisition unit.

The display unit 34 presents a display screen to the user. The display unit 34 displays an operating screen related to the registration of the photograph data of the driver’s license and an input screen related to the electronic consent related to carrying the driver’s license. The display unit 34 displays a display screen presenting candidates for private room spaces that can be borrowed, including vehicle cabins.

The input unit 35 receives input by the user. The input unit 35 receives operational input related to the registration of photograph data of the driver’s license and operational input related to the electronic consent related to carrying the driver’s license, for example.

The position information acquisition unit 36 acquires the position information of the user terminal 3. The position information acquisition unit 36 has a position sensor as its hardware configuration. The position sensor may be a GPS sensor or a sensor acquiring the position information using access points of Wi-Fi or the like, a Bluetooth (registered trademark) Low Energy (BLE) beacon, or the like. The position information acquisition unit 36 may further have an orientation sensor, such as a gyro sensor, acquiring the orientation of the user terminal 3.

The owner terminal 5 is an operating terminal used by the owner of the vehicle 6 who lends out a vehicle cabin to be used as a private room in the private room space matching service, that is, an owner who wants to lend out the vehicle cabin of the vehicle 6 as a private room space through the private room space matching system 1. The owner terminal 5 is an operating terminal outputting vehicle information including a lending condition indicating whether at least a partial period of a period during which the vehicle 6 can be lent out is designated as a standing period in which the vehicle 6 is not traveling or an autonomous traveling period. As the owner terminal 5, various portable terminals can be used as appropriate, such as PCs, tablet terminals, smartphones, and wearable devices such as smart watches. Stationary terminals such as ordinary PCs may also be used as the user terminal 5. In addition, a navigation apparatus installed in the vehicle 6 can be used as the owner terminal 5.

The owner terminal 5 is not limited to a terminal directly operated by the owner who has the vehicle 6 but may also be implemented by an artificial intelligence (AI) system configured to be able to execute processing to lend out the vehicle cabin on commission from the owner. The AI system has a model the parameters of which are determined so as to output locations and time slots in which the vehicle cabin can be used as a private room space in response to input such as the use history or the use forecast of the vehicle 6 by the owner, the current position, or schedule information indicating the schedule of the owner, for example. The AI system may be a terminal independent of the vehicle 6 or be a terminal embedded in the vehicle 6 that can autonomously travel, such as a robot car.

FIG. 1 exemplifies owner terminals 5a and 5b as the owner terminal 5. The owner terminal 5a is an example of the owner terminal 5 used by the owner who has or manages vehicles 6a and 6b as the vehicle 6. The owner terminal 5b is an example of the owner terminal 5 used by the owner who has or manages a vehicle 6c as the vehicle 6. In the private room space matching system 1, there may be one unit, or three or more units of a plurality units of owner terminals 5. Each owner may have or manage three or more units of a plurality units of vehicles 6.

Although FIG. 1 exemplifies a passenger car as the vehicle 6 having a private room space, this is not limiting. The vehicle 6 is only required to have the vehicle cabin as a private room space, and the vehicle cabin of campers, the cargo area of trucks, or the passenger cabin of buses may be used. In other words, in the private room space matching system 1 according to the present embodiment, the cargo area of trucks and the passenger cabin of buses are also examples of the vehicle cabin of the vehicle 6. The vehicle cabin is only required to be at least partially shielded from the outside and may be the vehicle cabin of convertible cars without a roof, for example. The roof of the vehicle cabin is not limited to a fixed type but may also be an operable type that can be opened and closed.

The vehicle 6 is on any drive system and may be a gasoline vehicle, an electric vehicle (EV), a hybrid vehicle, or a fuel cell vehicle.

FIG. 3 is a block diagram of an example of a configuration of the owner terminal 5 according to the embodiment. As illustrated in FIG. 3, the owner terminal 5 has a controller 51, a storage 52, a communication unit 53, a display unit 54, and an input unit 55.

The controller 51 controls the entire operation of the owner terminal 5. The controller 51 has a processor and a memory as its hardware configuration. The controller 51 executes a computer program 521 loaded onto the memory by the processor to implement a lending function 511.

In the lending function 511, the controller 51 registers vehicle information 522 on the vehicle 6 to be lent out by the owner. Specifically, the controller 51 acquires information to identify the vehicle 6 to be lent out as a private room space. The controller 51 sets a designation condition in accordance with the output of the input unit 55 in response to operational input by the owner. The controller 51 associates information indicating the designation condition with the information to identify the vehicle 6 and records them in the storage 52 as the vehicle information 522. The vehicle information 522 will be described below.

The storage 52 stores therein various data for use in the owner terminal 5. As illustrated in FIG. 3, the storage 52 records the computer program 521 and the vehicle information 522.

As described above, the vehicle information 522 includes the information to identify the vehicle 6 and the information indicating the designation condition.

The information to identify the vehicle 6 is the photograph data of the vehicle 6 acquired by a camera of the input unit 55, for example. The photograph data of the vehicle 6 is not limited to the photograph data taken by the owner terminal 5 but may also be image data acquired from outside the owner terminal 5. The information to identify the vehicle 6 is not limited to photograph or image data but may also be text data or the like indicating the model, the model year, installed equipment, or the like.

The information indicating the designation condition includes the lending condition, a lending location, and a reservable time slot.

The lending condition is information designating the traveling state of the vehicle 6 when the vehicle 6 is lent out. Specifically, the lending condition is information indicating whether at least a partial period of a period during which the vehicle 6 can be lent out is designated as a standing period in which the vehicle is not traveling or an autonomous traveling period. As the lending condition, the standing period, the autonomous traveling period, or a drivable period can be designated, for example.

As an example, when the standing period is designated, the vehicle 6 can be lent out only during a period of standing. In this case, the user who has borrowed it can use the vehicle cabin in a parking lot in which the vehicle 6 is parked, for example, and is not allowed to cause the vehicle 6 to travel. This can prevent delays in returning due to traffic congestion, for example, allowing the owner to lend out the vehicle 6 only during a period in which he or she does not use it, without disrupting his or her own use after lending. The owner can also lend out the vehicle cabin of the vehicle 6 that is being charged when the vehicle 6 is a plug-in hybrid vehicle (PHV) or an EV, for example.

As an example, when the autonomous traveling period is designated, the vehicle 6 can be lent out only during a period of autonomous traveling by self-driving. In this case, the user who has borrowed the vehicle 6 can only use the vehicle cabin only during a period when the vehicle 6 is autonomously traveling by self-driving, for example, and is not allowed to cause the vehicle 6 to travel as a driver. This allows the owner to lend out the vehicle 6 regardless of the driving skills of the user who borrows the vehicle 6. The owner can lend out the vehicle 6 even while the vehicle 6 is being deadheaded. In addition, the user can use the vehicle cabin while moving around.

As an example, when the drivable period is designated, the vehicle 6 can be lent out in the reservable time slot, just like a typical rental car. This allows the user who has borrowed it to use the vehicle cabin that is standing or autonomously traveling or to drive the vehicle 6 to move around. The user can also move the vehicle 6 to take a meal break or use the vehicle cabin at a desired location such as in a quiet environment.

The lending place is a piece of information designating a location where the vehicle 6 is lent out. When an autonomous traveling period or a drivable period is designated as the lending condition, for example, a return location of the vehicle 6 can be further designated. The lending location may be text data of “Parking Lot A in front of the station or the like” depending on the subjectivity of the owner or may be position information transmitted by a position sensor of GPS or the like mounted on the vehicle 6 to be lent out. When using the position information of vehicle 6, the position information of the vehicle 6 is transmitted to the management device 7 via the network 9, for example, and the position of the vehicle 6 is dynamically determined by the management device 7.

The reservable time slot is a piece of information designating a period during which the vehicle 6 can be lent out.

The lending condition is not limited to state information, location information, or time information, and any desired conditions can be set, such as whether pets are allowed, whether eating and drinking are allowed, whether smoking is allowed, whether use by multiple peoples are allowed, and whether use by a specific group on a social networking service (SNS) is allowed.

The communication unit 53 communicates with the outside via the network 9. The communication unit 53 transmits the vehicle information 522 to the management device 7, for example.

The display unit 54 presents a display screen to the user. The display unit 54 displays an operating screen related to the registration of the vehicle information 522 regarding the vehicle 6 to be lent out by the owner.

The input unit 55 receives input by the user. The input unit 35 receives operational input related to the registration of the vehicle information 522 regarding the vehicle 6 to be lent out by the owner, for example.

The management device 7 is an apparatus managing the entire private room space matching system 1 and managing the vehicle cabins of the vehicles 6 as objects to be lent out in the private room space matching service. The management device 7 is operated by the provider of the private room space matching service, for example. Specifically, the management device 7 is an apparatus executing processing matching the owner who wants to lend out the vehicle cabin of the vehicle 6 as a private room space and the user who wants to borrow a private room space suitable for the mobile environment, not limited to the vehicle cabin, with each other at least on condition of the presence of holding a driver’s license. More specifically, the management device 7 selects the vehicle 6 at least the vehicle cabin of which is available to the user from a plurality of vehicles 6 including vehicles 6 in a standing period in a lendable period based on management information 722, matching permission information 723, and the driver’s license information 322 from the user terminal 3. The management device 7 is an apparatus outputting the candidate information indicating the selected vehicle 6 to the user terminal 3. As the management device 7, a server apparatus, an apparatus implemented in a cloud system, or the like can be used as appropriate. The management device 7 may include a combination of a plurality of apparatuses, for example. In other words, the processing executed by the management device 7 in private room space matching processing according to the embodiment may be implemented by distributed processing by the apparatuses.

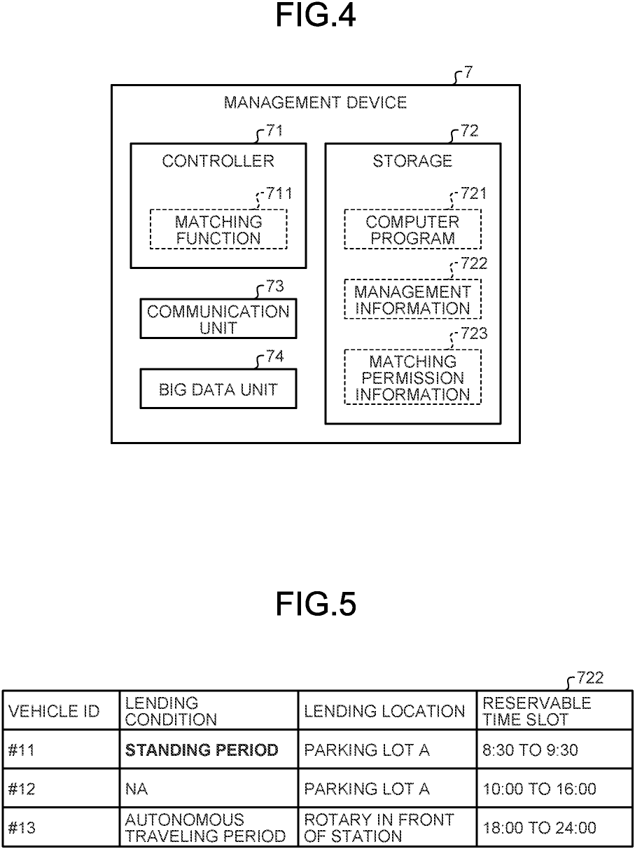

FIG. 4 is a block diagram of an example of a configuration of the management device 7 according to the embodiment. As illustrated in FIG. 4, the management device 7 has a controller 71, a storage 72, a communication unit 73, and a big data unit 74.

The controller 71 controls the entire operation of the management device 7. The controller 71 has a processor and a memory as its hardware configuration. The controller 71 executes a computer program 521 loaded onto the memory by the processor to implement a matching function 711.

In the matching function 711, the controller 71 matches candidates for private room spaces including the vehicle cabin of the vehicle 6 registered by the owner terminal 5 and a request for a private room space suitable for the mobile environment from the user terminal 3 with each other at least on condition of the presence of holding a driver’s license. Specifically, the management device 7 selects the vehicle 6 at least the vehicle cabin of which is available to the user from a plurality of vehicles 6 including vehicles 6 in a standing period in a lendable period based on the management information 722, the matching permission information 723, and the driver’s license information 322 from the user terminal 3.

More specifically, the controller 71 acquires the driver’s license holding information indicating the presence of holding the driver’s license from the user terminal 3 and performs user registration in association with a user ID uniquely identifying the user. The controller 71 acquires the information to identify the vehicle 6 from the owner terminal 5 and performs owner registration and vehicle registration in association with an owner ID uniquely identifying the owner and a vehicle ID uniquely identifying the vehicle 6.

The controller 71 further acquires the information indicating the designation condition from the owner terminal 5 and records the information indicating the designation condition in the storage 72 as the management information 722. The controller 71 acquires the driver’s license carrying information from the user terminal 3 and selects a candidate for a private room space suitable for the mobile environment based on the management information 722 and the matching permission information 723. The management information 722 and the matching permission information 723 will be described below.

The storage 72 stores therein various types of data for use in the management device 7. As illustrated in FIG. 4, the storage 72 records a computer program 721, the management information 722, and the matching permission information 723.

The management information 722 is information based on the vehicle information 522 from the owner terminal 5. Specifically, the management information 722 is one or more pieces of vehicle information 522 received from the owner terminal 5, that is, the vehicle information 522 for each vehicle 6. FIG. 5 is a diagram of an example of the management information 722 according to the embodiment. FIG. 5 exemplifies the management information 722 of the vehicle 6 with a vehicle ID of “#11” with a lending condition of “standing period,” a lending location of “Parking Lot A,” and a reservable time slot of “8:30 to 9:30.” FIG. 5 also exemplifies the management information 722 of the vehicle 6 with a vehicle ID of “#12” with a lending condition of “NA,” that is, the drivable period, a lending location of “Parking Lot A,” and a reservable time slot of “10:00 to 16:00.” FIG. 5 also exemplifies the management information 722 of the vehicle 6 with a vehicle ID of “#13” with a lending condition of “autonomous traveling period,” a lending location of “rotary in front of station,” and a reservable time slot of “18:00 to 24:00.”

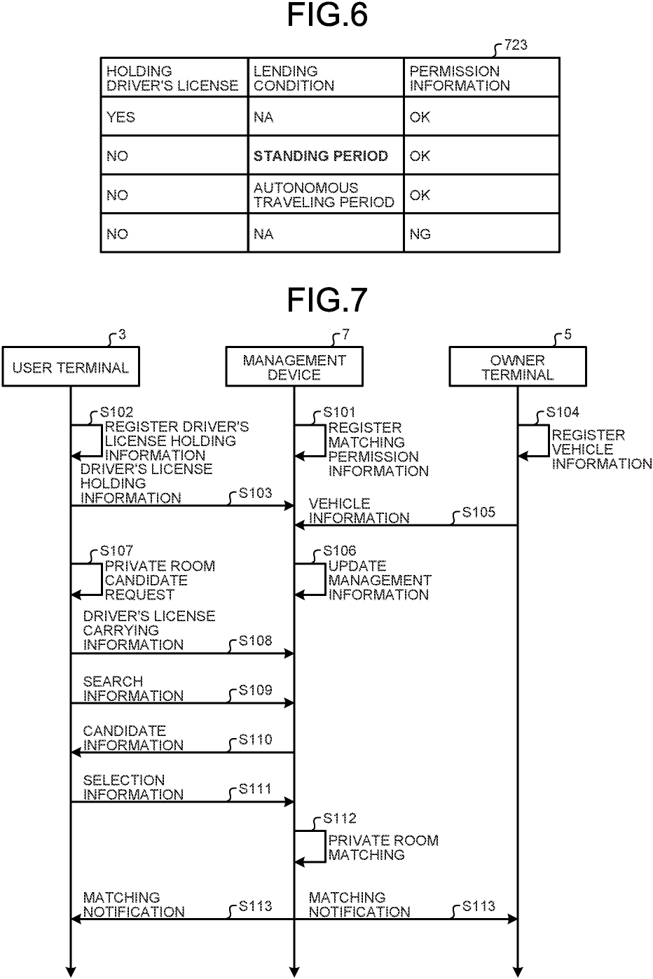

The matching permission information 723 is information in which correspondences among whether vehicles are in respective standing periods, whether users are holding respective driver’s licenses, and whether vehicle lending is permitted are registered in advance. The matching permission information 723 is, as an example, information indicating whether the condition of the user who borrows the vehicle 6 and the lending condition of the owner who lends out the vehicle 6 can be matched with each other. FIG. 6 is a diagram of an example of the matching permission information 723 according to the embodiment. As illustrated in FIG. 6, the matching permission information 723 indicates correspondences among a driver’s license holding state, the lending condition, and permission information. FIG. 6 exemplifies a case in which when the driver’s license holding state is “YES,” the permission information is “OK” regardless of the lending condition, and the case can be a candidate for a private room space. FIG. 6 also exemplifies a case in which the driver’s license holding state is “NO,” the permission information is “OK” only when the lending condition is “standing period” or “autonomous traveling period,” and the case can be a candidate for a private room space.

The determination of whether the user is required to hold a driver’s license when a self-driving car performing autonomous traveling is lent out to the user, for example, can vary depending on national or regional laws and regulations. Thus, the matching permission information 723 is registered for each country, region, or administrative division in which the private room space matching service is provided, for example. As an example, the matching permission information 723 is associated with each of a plurality of codes indicating countries, regions, or administrative divisions. The driver’s license referred to here is a driver’s license for automobiles, and the country, the region, or the administrative division that issued the driver’s license is referred to, and it is determined whether the driver’s license is valid in the country, the region, or the administrative division where the vehicle 6 is lent out. As an example, even in a case of holding a driver’s license of a country X, when the place in which the vehicle 6 is used is a country Y, if the driver’s license of the country X is not valid in the country Y, or if the prescribed application has not been made in advance, the driver’s license holding state is determined to be a state of not holding.

The matching permission information 723 is updated at any time in response to changes in the laws and regulations of the place in which the service is provided, for example. The updating of the matching permission information 723 may be done by an operator or be performed automatically in response to input of information on changes in the laws and regulations.

The communication unit 73 communicates with the outside via the network 9. The communication unit 73 acquires the driver’s license information 322 from the user terminal 3 and the vehicle information 522 from the owner terminal 5, for example. The communication unit 73 outputs the candidate information including information indicating the selected vehicle 6 as a lending candidate to the user terminal 3. The communication unit 73 is an example of the acquisition unit.

The big data unit 74 generates big data from data collected regarding private room space matching. The big data unit 74 generates an index for use as a data lake. The big data unit 74 performs noise and personal information cleaning processing on the collected data or the generated big data.

The big data unit 74 can use the accumulated big data via the data lake to analyze the number of needs of users seeking the mobile environment by district, by time slot, by the length of stay, or by user attribute, for example. The analysis data on the number of needs obtained by the analysis can be utilized for other uses for pay or free of charge.

One example of utilizing the analysis data on the number of needs for gratuitous uses may be its use in sales to acquire private room owners who provide vehicle cabins to the private room space matching service. The acquisition of the private room owners is essential for the development and further expansion of this service. The provider of this service can use the analysis data on the number of needs as back data in acquiring the private room owners, for example. The private room owners can refer to the analysis data to determine whether to provide private rooms to this service and appropriate prices, for example. The provider of this service can provide the above decision materials to the private room owners and can also improve the efficiency of sales activities such as determining districts and private room owners for which marketing is carried out in accordance with the demand for private room spaces.

One example of utilizing the analysis data on the number of needs for gratuitous uses may be its use for providing information to users who look for private room spaces using this service. The users who borrow private room spaces are essential for the development and further expansion of this service. The provider of this service provides information on popular areas for a user attribute to which a user belongs to the user based on the analysis data on the number of needs, for example. The information on popular areas can be useful information for the user when looking for a private room.

One example of utilizing the analysis data for pay on the number of needs may be its use to gather kitchen cars in areas in which lunch break usage is estimated to be high in the lunch time slot or to sell the analysis data on the number of needs as needs information to food delivery service companies.

Another example may be its use to sell the analysis data on the number of needs to national, regional, or other administrations. The administrations having been provided with the analyzed data can utilize it as reference data in carrying out urban planning.

Another example may be its use to sell the analysis data on the number of needs to advertising companies or companies requesting advertising. The advertising companies and the companies requesting advertising having been provided with the analysis data will be able to implement marketing strategies, such as gathering advertising cars, to areas with high concentrations of certain attributes, such as women, for example, according to the attributes.

Whether uses are for pay or free of charge is only by way of example and can be determined as appropriate in accordance with which entity will perform the operation of the management device 7 and the utilization of the analysis data on the number of needs, for example. When other business entities perform sales activities related to acquiring private room owners, such as when this service is provided through an application programming interface (API), for example, the above use can be utilization for pay.

In the private room space matching system 1, the management device 7 may be configured to be able to access a database storing therein the management information 722, the matching permission information 723, processed data by the big data unit 74, map information, and the like via a computer-readable recording medium or a portable external storage device. As the computer-readable recording media, a compact disc read only memory (CD-ROM), a flexible disk (FD), a compact disc recordable (CD-R), a digital versatile disc (DVD), or the like can be used as appropriate, for example. As the portable external storage device, a hard disk drive (HDD), a solid state drive (SSD), a flash memory, or the like can be used as appropriate.

As the processor of each of the controllers 31, 51, and 71, various processors such as a central processing unit (CPU), a graphics processing unit (GPU), an application specific integrated circuit (ASIC), and a field programmable gate array (FPGA) can be used as appropriate.

As the memory of each of the controllers 31, 51, and 71, a random access memory (RAM) can be used, for example. Each of the storages 32, 52, and 72 has various storage media or storage devices such as a read only memory (ROM), a hard disk drive (HDD), a solid state drive (SSD), and a flash memory as its hardware configuration. Each of the storages 32, 52, and 72 may be further provided with a RAM to temporarily store therein data being worked on.

Each of the communication units 33, 53, and 73 has a communication circuit for wired communication, a communication circuit for wireless communication, or a communication circuit for a combination of these as its hardware configuration. As the communication circuit for wireless communication, communication circuits provided for various standards such as 3G, 4G, 5G, 6G, Wi-Fi (registered trademark), and Bluetooth (registered trademark) can be used as appropriate.

Each of the display units 34 and 54 has a liquid crystal display, an organic electroluminescence (EL) display, or a projector as its hardware configuration. Each of the display units 34 and 54 may be configured as an output unit capable of presenting information to the user through audio output by a speaker or the like, not limited to display.

Each of the input units 35 and 55 has a touch panel provided on the display face of each of the display units 34 and 54, for example, and outputting information according to a touched position as its hardware configuration. The input unit 55 further has a camera for acquiring the photograph data of the vehicle 6 as its hardware configuration. The input unit 35 may further have a camera to acquire the photograph data of the driver’s license.

Each of the input units 35 and 55 may have other input devices such as a keyboard, a mouse, and a microphone receiving voice input from the user, not limited to the touch panel.

Although the present embodiment describes the private room space matching system 1 using a case in which the user terminal 3 and the owner terminal 5 are each connected to the management device 7 via the network 9 as an example, this is not limiting.

As an example, the owner of the vehicle 6 using the owner terminal 5 and a manager providing the private room space matching system 1 using the management device 7 can be the same. Alternatively, the owner who parks the vehicle 6 in a parking lot in which the management device 7 is installed can use the owner terminal 5 in the parking lot. In these cases, the owner terminal 5 may be directly connected to the management device 7 using a dedicated wired or wireless line, or the owner terminal 5 and the management device 7 may be integrally configured.

As another example, the user can use the user terminal 3 at a location in which the management device 7 is installed. In this case, the user terminal 3 may be directly connected to the management device 7 using a dedicated wired or wireless line, or the user terminal 3 and the management device 7 may be integrally configured.

As another example, the owner who parks the vehicle 6 in a parking lot, the parking lot being installed with the management device 7, can use the owner terminal 5, while the user can use the user terminal 3. In this case, at least one of the user terminal 3 and the owner terminal 5 may be directly connected to the management device 7 using a dedicated wired or wireless line or may be configured integrally with the management device 7. Alternatively, the user terminal 3 and the owner terminal 5 may be integrally configured, or the user terminal 3, the owner terminal 5, and the management device 7 may be integrally configured.

The following describes the operation of the private room space matching system 1 according to the embodiment with reference to the accompanying drawings. The flow of the processing described below is by way of example, and changes in the processing order, deletion of partial processing, and addition of other processing can be made.

FIG. 7 is a sequence diagram of an example of a procedure of the private room space matching processing according to the embodiment.

First, the registration of the matching permission information 723 is performed at the management device 7 (S101). The flow at S101 is performed before the start of providing the matching service by the private room space matching system 1, for example. The flow at S101 is repeatedly executed at any time in accordance with changes in traffic laws and regulations or expansion of service providing areas, for example, and the matching permission information 723 is updated.

The registration of the driver’s license holding information is performed at the user terminal 3 (S102). As an example, the photograph data of a driver’s license is acquired as the driver’s license holding information. The acquired driver’s license holding information is transmitted from the user terminal 3 to the management device 7 and is registered in the management device 7 in association with the user ID uniquely identifying the user (S103).

At the owner terminal 5, the registration of the vehicle information 522 is performed (S104). As described above, the vehicle information 522 includes the information to identify the vehicle 6 and the information indicating the designation condition. The vehicle information 522 regarding each vehicle 6 from the owner terminal 5 is transmitted to the management device 7 (S105) and is recorded in the management device 7 as the management information 722 (S106).

Subsequently, in response to a private room candidate request at the user terminal 3 (S107), the flow of private room candidate matching (S108 to S113) is started.

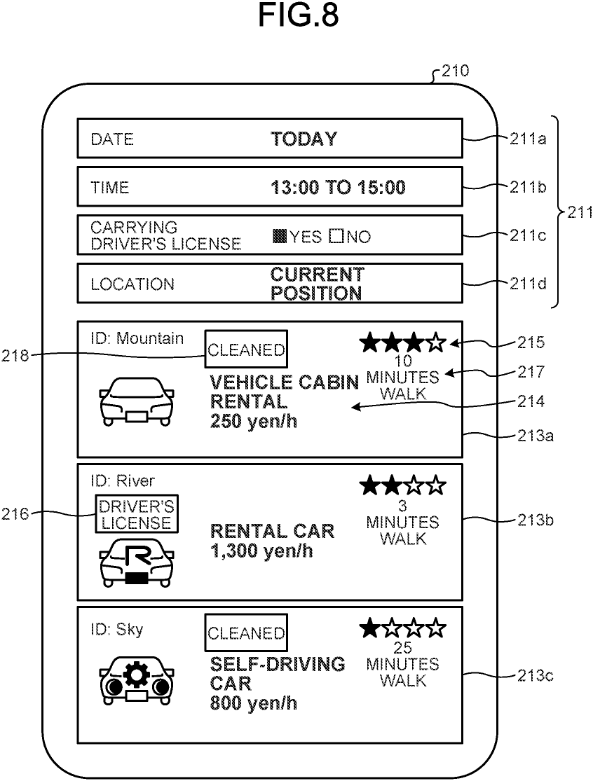

FIG. 8 is a diagram of an example of a display screen 210 displayed on the user terminal 3 in the private room space matching processing according to the embodiment. The display screen 210 includes an operating screen 211 for the private room candidate request (S107). The user sets search conditions for a mobile environment, that is, a private room space using the operating screen 211. The user enters a date 211a and a time 211b on which a private room is desired to be borrowed, search information of a location 211d as a search starting point, and driver’s license carrying information 211c. The user can designate the current position or a future destination to be visited as the search starting point, for example. FIG. 8 exemplifies a case in which the user enters “YES” as the driver’s license carrying information 211c to electronically consent to carrying a driver’s license.

The driver’s license carrying information (S108) and the search information (S109) set by the user are each transmitted from the user terminal 3 to the management device 7. The driver’s license carrying information and the search information may be transmitted as pieces of information independent of each other as exemplified in FIG. 7 or may be transmitted collectively as a borrowing request. It is possible that the driver’s license holding information is electronically managed, such as being registered in advance in the management device 7 or being freely acquirable from the outside. Thus, in the case of countries or regions in which carrying a driver’s license is not required, the driver’s license carrying information is not necessarily transmitted.

The management device 7 generates candidate information on private room spaces based on the set search conditions for the mobile environment, the management information 722, and the matching permission information 723 and transmits the candidate information on private room spaces to the user terminal 3 (S110).

As an example, when the user is in a state of not holding a driver’s license, the management device 7 selects the vehicle 6 in a standing period or an autonomous traveling period as the vehicle 6 at least the vehicle cabin of which is available and generates the candidate information indicating the selected vehicle 6.

The user terminal 3 displays the candidate information on private room spaces received from the management device 7 on the display screen 210. As illustrated in FIG. 8, for example, the display screen 210 displays candidates 213a, 213b, and 213c in list form as the candidate information on private room spaces. The display of each of the candidates 213a, 213b, and 213c includes the display of the owner ID, rental information 214 indicating the type and the fee of the rental, recommendation ranking 215, and a travel time 217 from the location designated as the search conditions for the mobile environment.

The type of the rental of the rental information 214 displays types such as vehicle cabin rental, which performs lending on condition of the standing period, a regular rental car, which also allows travel, and self-driving rental, which performs lending on condition of the autonomous traveling period of a self-driving car. For the regular rental car, which also allows travel, for example, holding and carrying a driver’s license are required, and thus an icon 216 indicating that a driver’s license is required can be displayed.

The recommendation ranking 215 is, as an example, determined based on at least one parameter out of a travel time from the location as a search starting point, that is, the current position of the user, a travel distance, a fee, and the driver’s license information 322 of the user. The recommendation ranking 215 may be able to designate which parameter is given priority.

Note that information on whether manned cleaning has already been performed in a maintenance time may be managed by the management device 7. In this case, as illustrated in FIG. 8, a cleaned icon 218 may be displayed on the display screen 210. The information on whether cleaning has already been performed may be used as a parameter to determine the recommendation ranking 215.

Thus, the management device 7 determines the ranking of the vehicle 6 as a lending candidate using at least one parameter out of the driver’s license information 322, the current position of the user, and the travel distance, the travel time, the fee, and the information whether cleaning has already been performed for each of the vehicles 6 as candidates to be lent out and outputs the recommendation ranking 215 indicating the determined ranking to the user terminal 3. The user terminal 3 displays the display screen 210 including the recommendation ranking 215 from the management device 7.

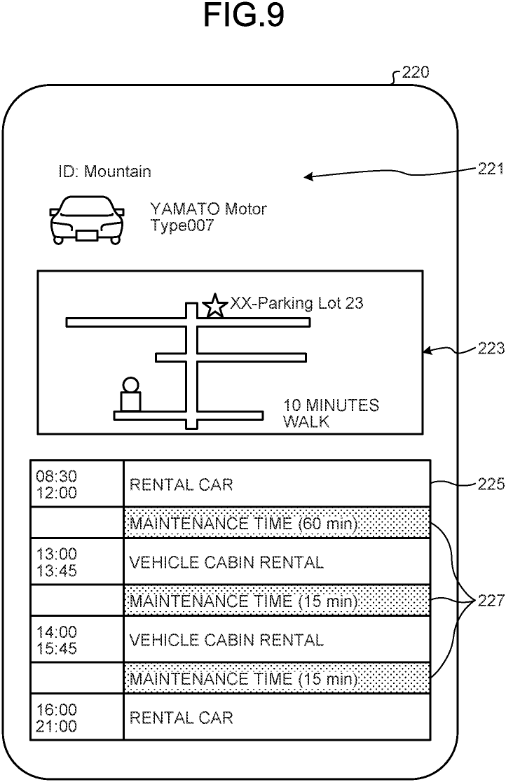

The user terminal 3 may display the detailed information of each of the candidates 213a, 213b, and 213c. FIG. 9 is a diagram of an example of a display screen 220 displayed in the private room space matching processing according to the embodiment. When the user selects the candidate 213a for a private room space on the display screen 210 in FIG. 8, for example, the display screen transitions to the display screen 220 in FIG. 9. The display screen 220 presents, as detailed information 221 of a private room space as a lending candidate, information on the maker, the model, and the appearance of the vehicle 6, route information 223 from the search starting point, and information 225 on the reservable time slot.

The route information 223 from the search starting point includes information on a lending position. FIG. 9 exemplifies a case displaying a human-shaped icon indicating the current position of the user and the lending position by a star icon and text data.

The information 225 on the reservable time slot can display the reservable time slot, the type of rental that can be borrowed in each time slot, and maintenance times 227 between the time slots, for example.

When a private room candidate and a reservation time are selected on the user terminal 3, they are transmitted to the management device 7 as selection information (S111).

Based on the selection information from the user terminal 3, the management device 7 performs matching of the vehicle 6 to be lent out as a private room space (S112). The management device 7 updates the management information 722 based on the reserved time. When matching completes, the management device 7 transmits a matching notification to each of the user terminal 3 and the owner terminal 5 (S113).

Note that the maintenance time 227 is a time, provided between a reservation and a reservation, for maintenances such as cleaning, refueling, and recharging the vehicle 6.

FIG. 9 exemplifies a case in which the maintenance time 227 is provided between the reservable time slots. Each maintenance time 227 varies depending on the form of the reservations therebefore and thereafter.

As an example, the maintenance time 227 when either one time slot therebefore or thereafter is the vehicle cabin rental, which lends out a vehicle in a standing period, is set to be not longer than the maintenance time 227 when either one time slot therebefore or thereafter is regular rental, which also allows travel of the vehicle. As an example, the maintenance time 227 when the time slot therebefore is the regular rental is set to be shorter than the maintenance time when the time slot thereafter is the vehicle cabin rental. This is because there is a risk of delayed return in the case of the regular rental, in which the vehicle 6 is allowed to travel, while there is a smaller risk of delayed return in the case of the vehicle cabin rental, in which the vehicle 6 is standing.

Thus, the private room space matching system 1 according to the embodiment includes the user terminal 3, the owner terminal 5, and the management device 7 configured to communicate with each of the user terminal 3 and the owner terminal 5. The user terminal 3 outputs the driver’s license information 322 indicating whether the user is holding a driver’s license to the management device 7. The owner terminal 5 outputs the vehicle information 522 including the lending condition indicating whether at least a partial period of a lendable period is designated as a standing period in which the vehicle 6 is not traveling. The management device 7 generates the candidate information indicating the vehicle 6 at least the vehicle cabin of which is available to the user based on the matching permission information, the management information 722 based on the vehicle information 522 from the owner terminal 5, and the driver’s license information 322 from the user terminal 3. The matching permission information is information in which correspondences among whether vehicles are in respective standing periods, whether the users are holding respective driver’s licenses, and whether vehicle lending is permitted are registered in advance. The management device 7 outputs the generated candidate information to the user terminal 3. The user terminal 3 displays a display screen showing the vehicle 6 at least the vehicle cabin of which is available to the user based on the candidate information from the management device 7.

This configuration allows the user to be presented with the vehicle 6 at least the vehicle cabin of which is available as candidates for available private room spaces. The vehicle cabins of vehicles are private room spaces generally having excellent sound insulation and are also suitable for resting, but many vehicles are parked in the streets with their vehicle cabins unused. It is also estimated that 90% of the vehicles are parked while being inactive. Thus, in addition to rental conference rooms and independent box-type private meeting rooms (private room booths), the user can make the vehicle cabin of the vehicle 6 a candidate for a private room space to be borrowed, thus easily satisfying a request for the use of a private room space by the user.

The private room space matching system 1 according to the embodiment allows even students who do not hold a driver’s license or travelers from abroad who do not hold a valid driver’s license to use the vehicle 6 in a standing period as a private room space. In countries, regions, or administrative divisions in which there are no lows and regulations on the use of the vehicle 6 if it is in the standing period, the service of the vehicle cabin rental is extremely effective.

It is also useful for the owner of the vehicle 6 to lend out the vehicle 6 on condition of the standing period. In the case of lending on the regular vehicle rental by the hour, for example, the proportion of a maintenance time slot between a reservation and a reservation increases to reduce an operating time related to lending, and to improve the operating rate of the vehicle 6, it will be lent out on a temporal basis, such as two hours or more, morning, or afternoon. Given these circumstances, the private room space matching system 1 according to the embodiment allows the owner to perform vehicle cabin rental on condition of the standing period as an idle time of the vehicle 6, such as a time slot between regular pieces of rental reserved for the morning and the afternoon. Thus, the private room space matching system 1 according to the embodiment can improve the overall operating hours of the vehicle 6 and can improve profitability.

In addition, when the owner has a time slot in which he or she uses the vehicle 6 to take his or her children to and from school, for example, and when wanting to use the vehicle 6 at an exact time slot, it is difficult to perform regular vehicle rental in the time slot before the time slot he or she uses, considering the possibility of delayed return of the vehicle 6. However, the private room space matching system 1 according to the present embodiment can achieve vehicle cabin rental lending out the vehicle 6 as a private room space and can thus lend out the vehicle 6 without considering a risk of delayed return.

In other words, the private room space matching system 1 according to the embodiment can present a private room space suitable for the mobile environment to the user and can effectively use the vehicle cabin as a private room space suitable for the mobile environment.

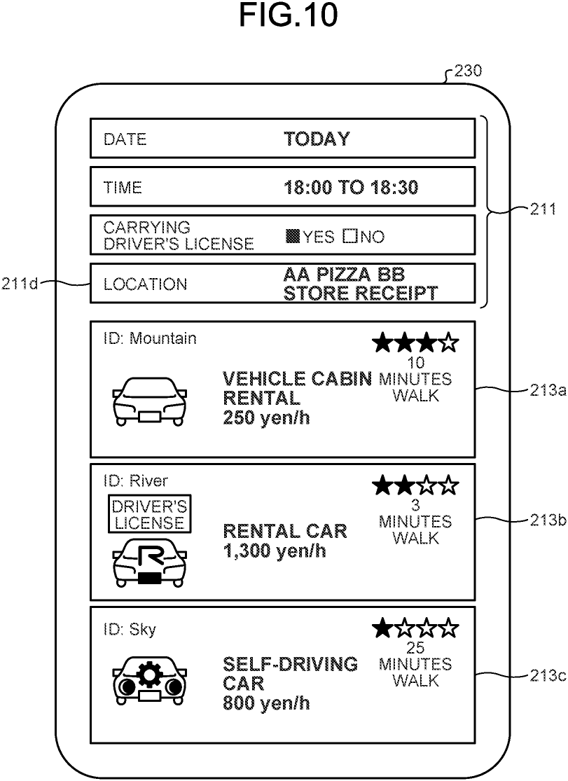

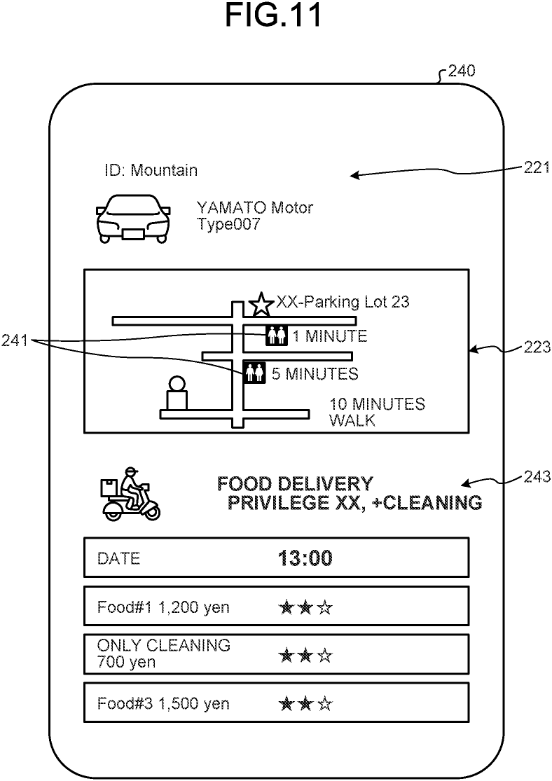

The location 211d as a search starting point in the search information of the mobile environment is not limited to the current location but can be a location at which food delivery can be received, for example. FIG. 10 is a diagram of an example of a display screen 230 displayed in the private room space matching processing according to the embodiment. Suppose that based on information on retailers providing food delivery, CC Station, DD Intersection, and EE Parking Lot are registered in the management device 7 in advance as possible delivery points for AA Pizza BB Store, for example. Suppose that the user has set the location 211d as a search starting point as AA Pizza BB Store receipt on the user terminal 3.

In this case, the private room space matching system 1 according to the embodiment selects private room candidates with CC Station, DD Intersection, and EE Parking Lot registered as the possible delivery points for AA Pizza BB Store as the search starting point as the candidate information on private room spaces and presents the private room candidates to the user. In this process, the search starting point may be narrowed down based on the home information of the user. Considering that the user will receive the food delivery on the way home, for example, narrowing down such as not using CC Station, which is farthest from the user’s home, as the search starting point can be done.

This configuration allows the user to borrow the vehicle cabin of the vehicle 6 parked at a position as a location and a route suitable for receiving delivery on the way home, for example, as a private room space. Retailers performing delivery can also perform delivery around locations suitable for performing delivery, thus achieving more efficient delivery, such as reductions in a delivery distance and a delivery time.

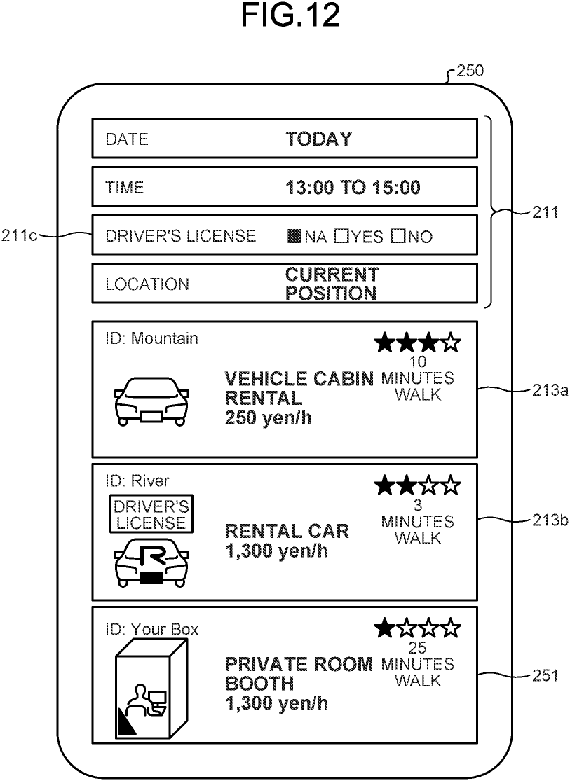

As described below with reference to FIG. 11, not limited to the food delivery, possible providing points of other services available in the vehicle cabin as a private room space can be set as appropriate as the location 211d as a search starting point in the search information of the mobile environment.

The detailed information 221 of the private room space as a lending candidate can also present delivery services that can be provided for a vehicle cabin as a candidate.

FIG. 11 is a diagram of an example of a display screen 240 displayed in the private room space matching processing according to the embodiment.

The display screen 240 includes information 243 on delivery services that can be provided for the vehicle cabin as a candidate. FIG. 11 exemplifies, as the information 243 on delivery services, the date and time, the type, the price, the recommendation ranking, and the like of the delivery services that can be provided. The information 243 on delivery services may include privilege information such as fee discounts and point grants related to the use of the delivery services. The information 243 on delivery services may be information on services available in the vehicle cabin as a private room space and may also be cleaning services or services of individual lessons for English conversation, musical instrument, or the like, not limited to food and beverage delivery services. As an example, services that can be performed within the time the user has reserved the vehicle 6 are presented. In this case, the management device 7 transmits the information 243 on the delivery service available when borrowing a vehicle of the candidate information to the user terminal 3 as part of the candidate information based on information on delivery services registered in advance in the storage 72.

Thus, the management device 7 outputs the information 243 on delivery services to the user terminal 3 as suggestion information suggesting delivery services available in the vehicle cabin of the vehicle 6 based on the lending location of the selected vehicle 6 at least the vehicle cabin of which is available and a lending period of the vehicle 6. The user terminal 3 displays the display screen 240 including the suggestion information from the management device 7.

The detailed information 221 of a private room space as a lending candidate can present facility information available from the vehicle cabin as a candidate, not limited to the information 243 on delivery services. The display screen 240 may include a facility map of restrooms 241 that are convenient for travel from the vehicle 6 in the route information 223 from the search starting point. The map is characterized by travel time information and route information from the use location of the vehicle 6 as a candidate being presented separately from travel time information from the location as a search starting point, such as the current position of the user, to the vehicle 6. FIG. 11 exemplifies the travel time information indicating that it takes 1 minute and 5 minutes from the vehicle 6 to the two restrooms 241, respectively. In this case, the management device 7 transmits the travel time information to the user terminal 3 as part of the candidate information based on information on a facility map registered in advance in the storage 72.

Thus, the management device 7 outputs the route information 223 from the search starting point to the user terminal 3 as map information indicating a facility available to the user who borrows the vehicle cabin and a travel time from the lending location of the vehicle 6 to the available facility based on the lending location of the selected vehicle 6 at least the vehicle cabin of which is available. The user terminal 3 displays the display screen 240 including the map information from the management device 7.

The facility information may be displayed in the case of restrooms in an identifiable manner, such as for men, for women, or for handicapped people or may be displayed filtered in accordance with a user attribute such as the sex of the user. As an example, the user terminal 3 displays a display screen including suggestion information indicating, among nearby facilities of the lending location of the vehicle 6 output from the management device 7 based on the lending location of the selected vehicle 6 at least the vehicle cabin of which is available and the attribute of the user, facilities available to the user of the attribute. Although this example exemplifies the information on restrooms as the facility information available from the vehicle cabin as a candidate, the facility information on convenience stores, vending machines, nursery facilities for infants and toddlers, or the like may also be presented.

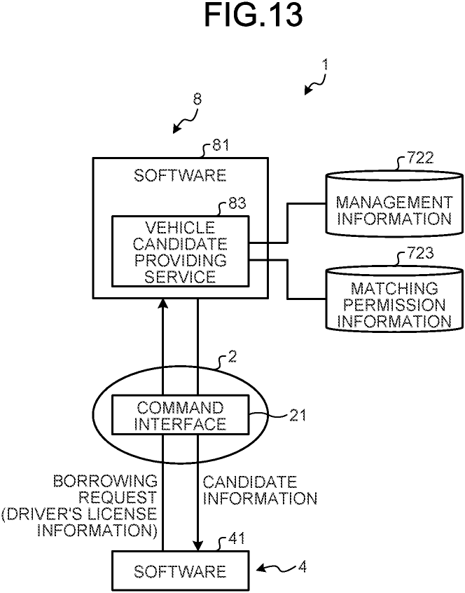

As the private room space as a lending candidate, a stationary private room space may be presented, not limited to the vehicle cabin. FIG. 12 is a diagram of an example of a display screen 250 displayed in the private room space matching processing according to the embodiment. FIG. 12 exemplifies a case in which the user has not entered the driver’s license carrying information 211c or has entered “NA” as the driver’s license carrying information 211c. In such a case, in addition to the candidates 213a and 213b for a vehicle cabin as a private room space, a private room booth as a stationary private room space satisfying the search information can be presented as a candidate 251. The private room booth is an example of the independent box-type private meeting room.

When the user in a state of not holding a driver’s license uses the vehicle cabin of the vehicle 6, the license plate may be shielded, the wheels may be mechanically locked, or the vehicle 6 may be moved to a state of not being installed on the road, such as a state of being parked in a parking lot, in accordance with laws and regulations. Whether to take these measures can be determined by the management device 7 based on the driver’s license information 322, for example. As an example, the management device 7 implements the measures by remotely operating the vehicles 6 and parking lot facilities based on the driver’s license information 322. As an example, the management device 7 notifies maintenance staff of the implementation of the measures based on the driver’s license information 322. The maintenance staff will implement the measures upon receiving the notification from the management device 7.

The private room space matching processing according to the embodiment may be a flow in which matching completes after confirmation about whether the owner accepts the lending is obtained in matching. In this process, evaluation information in previous use by the user may be presented to the owner.

### Second Embodiment

The present embodiment describes an aspect in which the private room space matching service according to the first embodiment is provided via an application programming interface (API). The communication method according to the present embodiment provides a service from one computer system to another computer system by executing an application, in which the computer systems are operatively connected to each other via a network.

Although the present embodiment exemplifies and describes a vehicle candidate providing service 83 in the private room space matching service, an aspect in which a vehicle lending support service is provided via the API is also possible. The vehicle candidate providing service 83 is a service included in the private room space matching service. The vehicle candidate providing service 83 is a service provided to the users of the user terminal 3 by the service provider operating the management device 7 in the private room space matching system 1 according to the first embodiment. Similarly, the vehicle lending support service is a service included in the private room space matching service. The vehicle lending support service is a service provided to the users of the owner terminal 5, that is, private room owners by the service provider operating the management device 7 in the private room space matching system 1 according to the first embodiment.

FIG. 13 is a diagram of an example of a configuration of the private room space matching system 1 providing the vehicle candidate providing service 83 via an API 2 according to the embodiment.

The private room space matching system 1 according to the present embodiment includes the API 2, a client system 4, and a service platform 8.

The API 2 is an interface provided by a service provider for users of the client system 4 to use the vehicle candidate providing service 83. The API 2 has a command interface 21. The command interface 21 is an interface for commands receiving input of the borrowing request and outputting the candidate information indicating the vehicle 6 that can be lent out.

The borrowing request includes a request for a candidate for a lending vehicle and the driver’s license information indicating whether the user who borrows the vehicle 6 is in a state of holding a driver’s license. The driver’s license information can be treated as the request for a candidate for a lending vehicle. Alternatively, when a driver’s license is not required for the use of a vehicle cabin space, the borrowing request does not necessarily include a driver’s license.

The candidate information is information provided from the service platform 8 based on the management information 722 and the matching permission information 723, indicating the vehicle 6 that can be lent out.

The client system 4 is a system used by users who want to borrow a private room space suitable for the mobile environment, not limited to the vehicle cabin. In the client system 4, the user terminal 3 according to the first embodiment is implemented as part of software 41, which is an application program executed on a customer’s system. The software 41 corresponds to the computer program 721 according to the first embodiment.

As illustrated in FIG. 13, the service platform 8 is a service platform for providing the candidate information indicating vehicle candidates that can be lent out to the client system 4 via the API 2. Software 81, which is an application program executed on the service platform 8, provides the vehicle candidate providing service 83 to the client system 4 via the API 2. The service platform 8 corresponds to the management device 7 according to the first embodiment. In other words, the management device 7 according to the first embodiment can also be implemented as the service platform 8 according to the present embodiment. The software 81 corresponds to the computer program 321 according to the first embodiment.

As described above, the database of the management information 722 stores therein the information on a plurality of vehicles 6 including vehicles 6 with a lending condition in which at least a partial period of a lendable period is designated as a standing period in which the vehicle 6 is not traveling.

As described above, the database of the matching permission information 723 stores therein the information in which correspondences among whether vehicles are in respective standing periods, whether the users are holding respective driver’s licenses, and whether vehicle lending is permitted are registered in advance.

The private room space matching system 1 according to the present embodiment can expect supply and demand for both the owner who lends out the vehicle 6 and the user who borrows the vehicle 6 to increase and profitability and convenience to improve in an area in which the customer’s system (the client system 4) is used. When the customer’s system is implemented as an API for the Web in a large commercial facility such as a shopping mall or an office building, for example, the owner of the vehicle 6 can estimate a high probability of use by users who visit the area and focus on placing the vehicle 6 to be lent out at locations with high travel convenience in that area. In addition, the user can expect to receive many suggestions of candidates to be lent out at locations with good travel convenience from the place where he or she visits.

The computer program to be executed by the units of the private room space matching system 1 according to the embodiments is recorded and provided in a computer-readable storage medium such as a CD-ROM, an FD, a CD-R, or a DVD, as an installable or executable file.

The computer program to be executed by the units of the private room space matching system 1 according to the embodiments may be stored in a computer connected to a network such as the Internet and provided by being downloaded via the network. The computer program to be executed by the units of the private room space matching system 1 according to the embodiments may be provided or distributed via a network such as the Internet.

The computer program to be executed by the units of the private room space matching system 1 according to the embodiments may be embedded and provided in a ROM, for example.

At least one of the embodiments described above can present a private room space suitable for a mobile environment to the user.

According to the present disclosure, private room spaces suitable for a mobile environment can be presented to users.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
an owner terminal configured to output vehicle information including a lending condition indicating whether at least a partial period of a lendable period is designated as a standing period in which a vehicle is not traveling;
a user terminal configured to output driver’s license information indicating whether a user is holding a driver’s license; and
a management device configured to:
select, based on matching permission information, in which correspondences among whether vehicles are in respective standing periods, whether users are holding respective driver’s licenses, and whether vehicle lending is permitted are registered in advance, the vehicle information from the owner terminal, and the driver’s license information from the user terminal, a vehicle at least a vehicle cabin of which is available to the user from among a plurality of vehicles including a vehicle in a standing period in a lendable period; and
output information indicating the selected vehicle at least the vehicle cabin of which is available to the user terminal.

2. The information processing system according to claim 1, wherein the management device is configured to select a vehicle in the standing period as the vehicle at least the vehicle cabin of which is available when the user is not holding the driver’s license.

3. The information processing system according to claim 1, wherein
the vehicle information further includes a lending condition indicating whether at least the partial period of the lendable period is designated as an autonomous traveling period in which the vehicle is autonomously traveling,
in the matching permission information, correspondences among whether the vehicles are in the respective standing periods or respective autonomous traveling periods, whether the users are holding the respective driver’s licenses, and whether the vehicle lending is permitted are registered in advance, and
the management device is configured to select a vehicle in the standing period or the autonomous traveling period as the vehicle at least the vehicle cabin of which is available when the user is not holding the driver’s license.

4. The information processing system according to claim 2, wherein
the vehicle information further includes a lending condition indicating whether at least the partial period of the lendable period is designated as an autonomous traveling period in which the vehicle is autonomously traveling,
in the matching permission information, correspondences among whether the vehicles are in the respective standing periods or respective autonomous traveling periods, whether the users are holding the respective driver’s licenses, and whether the vehicle lending is permitted are registered in advance, and
the management device is configured to select a vehicle in the standing period or the autonomous traveling period as the vehicle at least the vehicle cabin of which is available when the user is not holding the driver’s license.

5. The information processing system according to claim 1, wherein the management device is configured to select the vehicle at least the vehicle cabin of which is available to the user based on the matching permission information associated with each of a plurality of codes indicating countries or regions.

6. The information processing system according to claim 2, wherein the management device is configured to select the vehicle at least the vehicle cabin of which is available to the user based on the matching permission information associated with each of a plurality of codes indicating countries or regions.

7. The information processing system according to claim 3, wherein the management device is configured to select the vehicle at least the vehicle cabin of which is available to the user based on the matching permission information associated with each of a plurality of codes indicating countries or regions.

8. The information processing system according to claim 4, wherein the management device is configured to select the vehicle at least the vehicle cabin of which is available to the user based on the matching permission information associated with each of a plurality of codes indicating countries or regions.

9. The information processing system according to claim 1, wherein
the vehicle information further includes information indicating a lending location of the vehicle, and
the management device is configured to output suggestion information to the user terminal based on the lending location of the selected vehicle at least the vehicle cabin of which is available and a lending period of the vehicle, the suggestion information suggesting a delivery service available in the vehicle cabin of the vehicle.

10. The information processing system according to claim 2, wherein
the vehicle information further includes information indicating a lending location of the vehicle, and
the management device is configured to output suggestion information to the user terminal based on the lending location of the selected vehicle at least the vehicle cabin of which is available and a lending period of the vehicle, the suggestion information suggesting a delivery service available in the vehicle cabin of the vehicle.

11. The information system according to claim 1, wherein
the vehicle information further includes information indicating a lending location of the vehicle, and
the management device is configured to output map information to the user terminal based on the lending location of the selected vehicle at least the vehicle cabin of which is available, the map information indicating an available facility and a travel time from the lending location of the vehicle to the available facility.

12. The information system according to claim 2, wherein
the vehicle information further includes information indicating a lending location of the vehicle, and
the management device is configured to output map information to the user terminal based on the lending location of the selected vehicle at least the vehicle cabin of which is available, the map information indicating an available facility and a travel time from the lending location of the vehicle to the available facility.

13. The information processing system according to claim 1, wherein
the vehicle information further includes information indicating a lending location of the vehicle, and
the management device is configured to output to the user terminal, based on the lending location of the selected vehicle at least the vehicle cabin of which is available and an attribute of the user, information indicating a facility available to the user of the attribute among nearby facilities of the lending location of the vehicle.

14. The information processing system according to claim 2, wherein
the vehicle information further includes information indicating a lending location of the vehicle, and
the management device is configured to output to the user terminal, based on the lending location of the selected vehicle at least the vehicle cabin of which is available and an attribute of the user, information indicating a facility available to the user of the attribute among nearby facilities of the lending location of the vehicle.

15. The information processing system according to claim 1, wherein
the vehicle information further includes information indicating a lending location of the vehicle, and
the management device is configured to:
select vehicles vehicle cabins of which are available from among the plurality of vehicles including the vehicle in the standing period in the lendable period;
determine ranking of the vehicles selected using at least one of the driver’s license information from the user terminal, a current position of the user, a travel distance of the user to the lending location of each of the selected vehicles, a travel time of the user to the lending location of each of the selected vehicles, a fee of each of the selected vehicles, and information on whether each of the selected vehicles has been cleaned, as a parameter; and
output information indicating the determined ranking to the user terminal.

16. The information processing system according to claim 2, wherein
the vehicle information further includes information indicating a lending location of the vehicle, and
the management device is configured to:
select vehicles vehicle cabins of which are available from among the plurality of vehicles including the vehicle in the standing period in the lendable period;
determine ranking of the vehicles selected using at least one of the driver’s license information from the user terminal, a current position of the user, a travel distance of the user to the lending location of each of the selected vehicles, a travel time of the user to the lending location of each of the selected vehicles, a fee of each of the selected vehicles, and information on whether each of the selected vehicles has been cleaned, as a parameter; and
output information indicating the determined ranking to the user terminal.

17. An information processing device comprising:
a memory configured to store therein matching permission information, in which correspondences among whether vehicles are in respective standing periods, whether users are holding respective driver’s licenses, and whether vehicle lending is permitted are registered in advance; and
a controller coupled to the memory and configured to:
acquire vehicle information including a lending condition indicating whether at least a partial period of a lendable period is designated as a standing period in which a vehicle is not traveling and driver’s license information indicating whether a user is holding a driver’s license;
select a vehicle at least a vehicle cabin of which is available to the user from among a plurality of vehicles including a vehicle in a standing period in a lendable period based on the matching permission information, the vehicle information, and the driver’s license information; and
output information indicating the selected vehicle at least the vehicle cabin of which is available.

18. A display terminal comprising:
an output unit configured to output driver’s license information indicating whether a user is holding a driver’s license; and
a controller configured to:
acquire information indicating a vehicle, at least a vehicle cabin of which is available to the user, selected from a plurality of vehicles including a vehicle in a standing period in a lendable period, based on matching permission information, in which correspondences among whether vehicles are in respective standing periods, whether users are holding respective driver’s licenses, and whether vehicle lending is permitted are registered in advance, vehicle information including a lending condition indicating whether at least a partial period of a lendable period is designated as a standing period in which a vehicle is not traveling, and the driver’s license information; and
cause a display unit to display a display screen indicating a vehicle at least an vehicle cabin of which is available to the user based on the information indicating the vehicle at least the vehicle cabin of which is available to the user.

19. An information processing method comprising:
storing matching permission information, in which correspondences among whether vehicles are in respective standing periods, whether users are holding respective driver’s licenses, and whether vehicle lending is permitted are registered in advance;
acquiring vehicle information including a lending condition indicating whether at least a partial period of a lendable period is designated as a standing period in which a vehicle is not traveling and driver’s license information indicating whether a user is holding a driver’s license;
selecting a vehicle at least a vehicle cabin of which is available to the user from among a plurality of vehicles including a vehicle in a standing period in a lendable period based on the matching permission information, the vehicle information, and the driver’s license information; and
outputting information indicating the selected vehicle at least the vehicle cabin of which is available.

20. A communication method of a computer system providing a service to another computer system by executing an application in which the computer systems are operatively connected to each other via a network,
the service being a vehicle providing service of providing information on a vehicle lendable to a user requesting borrowing of a private room space,
the service being provided via an application programming interface, and
the application programming interface having a command interface configured to:
receive input of a request for a candidate for a lending vehicle and driver’s license information indicating whether a user who borrows a vehicle is holding a driver’s license; and
output the information on the lendable vehicle based on matching permission information and a database of a plurality of vehicles including a vehicle with a lending condition in which at least a partial period of a lendable period is designated as a standing period in which the vehicle is not traveling, the matching permission information being information in which correspondences among whether vehicles are in respective standing periods, whether users are holding respective driver’s licenses, and whether vehicle lending is permitted are registered in advance.
